(19) United States
(12) Patent Application Publication
(10) Pub. No.: US 2009/0313233 A1
(43) Pub. Date: Dec. 17, 2009

(54) INSPIRATION SUPPORT APPARATUS, INSPIRATION SUPPORT METHOD AND INSPIRATION SUPPORT PROGRAM

(76) Inventor: Ken Hanazawa, Tokyo (JP)

Correspondence Address: DICKSTEIN SHAPIRO LLP, 1633 Broadway, NEW YORK, NY, 10019, US

(21) Appl. No.: 12/094,538

(22) PCT Filed: Sep. 1, 2006
(86) PCT No.: PCT/JP2006/317326

§ 371 Date: May 21, 2008

(30) Foreign Application Priority Data
Nov. 22, 2005 (JP) 2005-337050

(51) Int. Cl. G06F 17/30

(52) U.S. Cl. 707/5; 707/6; 707/E17.075; 707/E17.044

(57) ABSTRACT

An inspiration support apparatus includes: a text database that stores a plurality of texts; a text mining section that analyzes the plurality of texts stored in the text database by text mining, and outputs a text that is a result of the mining; a keyword set database that stores conversion keywords; a keyword extraction section that extracts a keyword from the text that is the result of the mining by using the conversion keywords stored in the keyword set database; a keyword conversion section that converts, with respect to the text that is the result of the mining, the keyword extracted by the keyword extraction section in the text into one of the conversion keywords stored in the keyword set database; and a result output section that outputs the text converted by the keyword conversion section.

### TECHNICAL FIELD

The present invention relates to an inspiration support apparatus for supporting inspiration of a new idea, an inspiration support method and an inspiration support program.

### BACKGROUND ART

As a method of supporting inspiration of a new idea, 4W1H conversion is known.

In this method, a value provided by an already-existing service is prepared in the form of a text; keywords corresponding to “who”, “why”, “where”, “when” and “how” are extracted from the text; and a new text is prepared by converting the extracted keyword into a different keyword. This prepared text supports inspiration of a new value not conventionally known and is used to discover a latent need.

On the other hand, in a text mining system, dependency analysis is performed on a text in a database to recognize the structures of a sentence, and a frequently appearing pattern is extracted on the basis of the frequency of appearance of partial structures of the sentence and is output as a mining result. Therefore the text mining system is capable of extracting sentences and keywords characterizing the database.

FIG. 1 is a block diagram showing an example of a text mining system. Referring to FIG. 1, the text mining system includes text DB 101, text analysis section 102, similar structure generation section 103, frequently appearing pattern detection section 104, result output section 105, and keyword set DB 106. Patent document 1 discloses an example of a conventional text mining system.

Patent document 1: Japanese Patent Laid-Open No. 2004-246491

### DISCLOSURE OF THE INVENTION

### Problems to be Solved by the Invention

The first problem is that, in the case of inspiration support using 4W1H conversion, preparation of texts before keyword conversion, extraction of keywords to be converted and conversion of extracted keywords must be performed by a human. This is because a method of preparing texts, a method of extracting and converting keywords are not obvious in most cases.

The second problem is that it is difficult to use the text mining system for inspiration support. This is because a method of using the text mining system for inspiration support is not obvious in most cases.

An object of the present invention is to perform efficient inspiration support.

### Means for Solving the Problems

To achieve the above-described object, an inspiration support apparatus according to the present invention includes: a text database that stores a plurality of texts; a text mining section that analyzes the plurality of texts stored in the text database by text mining, and outputs text that is a result of the mining; a keyword set database that stores conversion keywords; a keyword extraction section that extracts a keyword from the text that is the result of the mining by using the conversion keywords stored in the keyword set database; a keyword conversion section that converts, with respect to the text that is the result of the mining, the keyword extracted by the keyword extraction section in the text into one of the conversion keywords stored in the keyword set database; and a result output section that outputs the text converted by the keyword conversion section.

Also, an inspiration support method according to the present invention, which is carried out by an inspiration support apparatus includes a text database that stores a plurality of texts and a keyword set database that stores conversion keywords, the method includes: a text mining step of analyzing the plurality of texts stored in the text database by text mining to output a text that is a result of the mining; a keyword extraction step of extracting a keyword from the text that is the result of the mining by using the conversion keywords stored in the keyword set database; a keyword conversion step of converting, with respect to the text that is the result of the mining, the extracted keyword in the text into one of the conversion keywords stored in the keyword set database; and a result output step of outputting the converted text.

According to the above-described invention, a text mining result characterizing a text database is used as a text in which keywords are to be converted, and a text having a meaning that is different from that of the text mining result is automatically produced by keyword conversion. This generated text supports the inspiration of a new idea.

Thus, it is possible to automate inspiration support and to perform inspiration support with efficiency. Also, use of text mining for inspiration support is made possible.

Preferably, the above-described inspiration support apparatus further includes a collation section that collates the text converted by the keyword conversion section with the texts in the text database and assigns an ordinal rank to the converted text on the basis of the result of collation, and the result output section outputs the converted text having the ordinal rank assigned by the collation section.

According to the above-described invention, an ordinal rank can be assigned to the text in which the keyword has been converted, on the basis of differences between the contents of this text and the contents of texts in the text database.

Therefore, for example, a text, which is different in meaning from the texts in the text database and which is likely to enable support of a new idea, can be assigned a higher ordinal rank. Accordingly, if texts in which keywords have been converted are rearranged according to their ordinal ranks, a user can easily find the text that is likely to enable support of a new idea.

Preferably, the above-described keyword set database stores, as the conversion keywords, synonyms or antonyms to be used in the text mining section.

According to the above-described invention, synonyms or antonyms used in text mining can also be used as conversion keywords.

Also, preferably, the keyword set database stores a plurality of conversion keyword candidates, and the keyword conversion section uses as the conversion keyword one of the conversion keyword candidates associated in advance with the text database.

According to the above-described invention, conversion keywords are changed according to the texts stored in the text database. Therefore the mining result text can be converted by using the conversion keywords most suitable for the texts stored in the text database.

Preferably, the above-described collation section assigns a higher ordinal rank to the text converted by the keyword conversion section if the frequency with which the text has appeared in the text database is lower.

According to the above-described invention, a text which is different in meaning from the texts in the text database and which is likely to enable support of a new idea, can be assigned a higher ordinal rank.

An inspiration support program according to the present invention that causes a computer, which is connected to a text database storing a plurality of texts and to a keyword set database storing conversion keywords, to execute inspiration support processing that includes:

text mining processing for analyzing the plurality of texts stored in the text database by text mining, and outputting a text that is the result of the mining; keyword extraction processing for extracting a keyword from the text that is the result of the mining by using the conversion keywords stored in the keyword set database;
keyword conversion processing for converting, with respect to the text that is the result of the mining, the extracted keyword in the text into one of the conversion keywords stored in the keyword set database; and result output processing for outputting the converted text.

According to the present invention, the above-described inspiration support method can be carried out by the above-described computer.

### ADVANTAGES OF THE INVENTION

According to the present invention, inspiration support using text mining can be automatized, because a mining result characterizing the text database is used as a text in which a keyword is to be converted, and because a text having a meaning that is different from that of the mining result can be automatically generated by keyword conversion.

### BRIEF DESCRIPTION OF THE DRAWINGS

FIG. 1 is a block diagram showing the configuration of an example of the related art;

FIG. 2 is a block diagram showing the configuration in the best embodiment for carrying out the first invention in the present invention;

FIG. 3 is a flowchart for explaining the operation in the best embodiment for carrying out the first invention;

FIG. 4 is a block diagram showing an example of the best embodiment for carrying out the first invention;

FIG. 5 is a diagram showing an example of conversion keywords; and

FIG. 6 is a diagram showing an example of conversion keywords.

### DESCRIPTION OF SYMBOLS

201 Text database
202 Text mining section
203 Keyword extraction section
204 Keyword conversion section
205 Collation section
206 Result output section
207 Keyword set database

### BEST MODE FOR CARRYING OUT THE INVENTION

The best mode for carrying out the present invention will be described in detail with reference to the drawings.

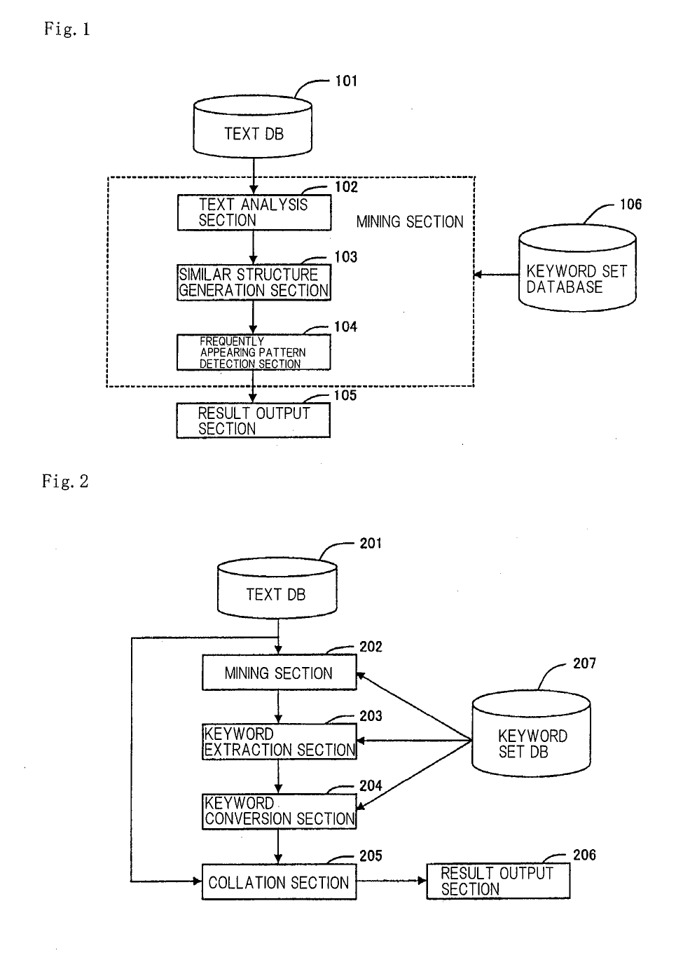

FIG. 2 is a block diagram showing an inspiration support apparatus according to an exemplary embodiment of the present invention.

Referring to FIG. 2, the inspiration support apparatus has text database 201, text mining section (hereinafter referred to as “mining section”) 202, keyword extraction section 203, keyword conversion section 204, keyword set database 207, collation section 205, and result output section 206.

Text database 201 stores a plurality of texts. Mining section 202 analyzes by text mining the plurality of texts stored in text database 201. “Text mining” is also referred to generally as “data mining”. These are also denoted as “mining” below.

Keyword set database 207 stores conversion keywords. For example, keyword set database 207 stores, as conversion keywords, conversion keywords such as synonyms and antonyms that are to be used in mining performed by mining section 202.

Keyword extraction section 203 extracts keywords from a text which is a result of mining. More specifically, keyword extraction section 203 uses conversion keywords stored in keyword set database 207 to extract keywords from a text which is a result of mining.

Keyword conversion section 204 converts keywords extracted by keyword extraction section 203 in the text, which is a result of mining, into conversion keywords stored in keyword set database 207.

Collation section 205 collates a text converted by keyword conversion section 204 with texts in text database 201 and ranks the converted text on the basis of the collation result. For example, collation section 205 assigns a higher ordinal rank (smaller number) to a text not in text database 201.

Result output section 206 outputs the text converted by keyword conversion section 204. That is, result output section 206 outputs the text to which an ordinal rank has been assigned by collation section 205.

Mining section 202, keyword extraction section 203, keyword conversion section 204 and collation section 205 may be implemented in a computer on which a program, which is recorded on a recording medium such as a computer-readable memory, is executed.

The inspiration support apparatus may be implemented as an inspiration support system including text database 201, mining section 202, keyword extraction section 203, keyword conversion section 204, keyword set database 207, collation section 205 and result output section 206.

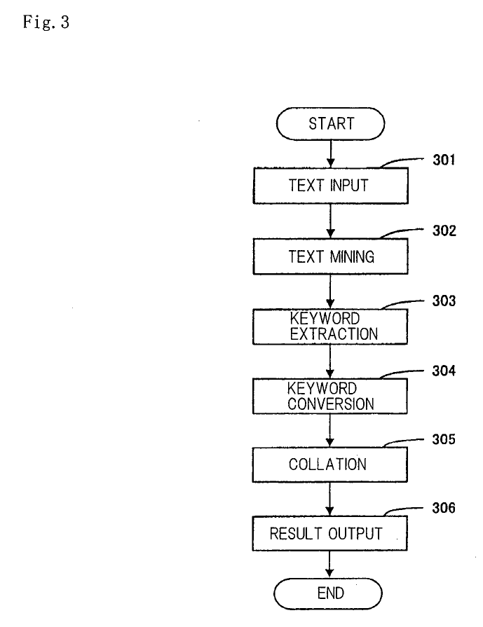

An example of the operation of the inspiration support apparatus will be described with reference to FIGS. 2 and 3. FIG. 3 is a flowchart for explaining an example of the operation of the inspiration support apparatus.

Description will be made by assuming that, in keyword set database 207, the following are stored: a who conversion keyword set in which keywords corresponding to “who” are collected, a why conversion keyword set in which keywords corresponding to “why” are collected, a where conversion keyword set in which keywords corresponding to “where” are collected, a when conversion keyword set in which keywords corresponding to “when” are collected, and a how conversion keyword set in which keywords corresponding to “how” are collected.

Also, keyword extraction section 203 is assumed to extract keywords corresponding to 4W1H (who, why, where, when and how) from a text which is the result of text mining by referring to keyword set database 207.

In step 301, a plurality of texts are input to text database 201. Then, in step 302, mining section 202 analyzes the texts stored in text database 201 by using text mining, and outputs the text as a result of text mining.

Mining section 202 provides the text which is a result of text mining to keyword extraction section 203. Tags for parts of speech or the like are attached to the text.

Keyword extraction section 203 accepts the text provided as a result of text mining and executes step 303.

In step 303, keyword extraction section 203 extracts keywords corresponding to 4W1H (who, why, where, when, how) from the text provided as a result of text mining, and provides the extracted keywords and the text provided as a result of text mining to keyword conversion section 204.

Keyword conversion section 204 accepts the extracted keywords and the text provided as a result of text mining and executes step 304.

In step 304, keyword conversion section 204 converts the extracted keywords by referring to keyword set database 207.

More specifically, keyword conversion section 204 converts the keywords extracted by keyword extraction section 203 in the text provided as a result of text mining into conversion keywords stored in keyword set database 207.

That is, keyword conversion section 204 converts a keyword corresponding to “who” extracted by keyword extraction section 203 into a different keyword in the “who” conversion keyword set, and converts a keyword corresponding to “why” extracted by keyword extraction section 203 into a different keyword in the “why” conversion keyword set.

Also, keyword conversion section 204 converts a keyword corresponding to “where” extracted by keyword extraction section 203 into a different keyword in the “where” conversion keyword set, converts a keyword corresponding to “when” extracted by keyword extraction section 203 into a different keyword in the “when” conversion keyword set, and converts a keyword corresponding to “how” extracted by keyword extraction section 203 into a different keyword in the “how” conversion keyword set.

Keyword conversion section 204 produces a plurality of keyword-converted texts by using combinations of these conversions. Keyword conversion section 204 provides the keyword-converted texts to collation section 205.

Collation section 205 accepts the keyword-converted texts and executes step 305.

In step 305, collation section 205 collates the texts converted by keyword conversion section 204 with the texts in text database 201 and assigns a higher ordinal rank (a smaller number) to any of the converted texts not existing in text database 201. Collation section 205 provides the texts after conversion that are assigned ordinal ranks to result output section 206.

Result output section 206 accepts the texts after conversion that are assigned ordinal ranks and executes step 306.

In step 306, result output section 206 outputs the texts after conversion that are assigned ordinal ranks. For example, result output section 206 displays the texts after conversion that are assigned ordinal ranks.

While in this example collation section 205 assigns a higher ordinal rank to a text after conversion that does not exist in text database 201, collation section 205 may alternatively assign ranks in ascending order respectively to texts in ascending order of the frequency with which the texts have appeared in database 201 by using a statistical technique.

Also, collation section 205 may define distances between the original keywords before conversion and the keywords after conversion by using a thesaurus, weight the keywords after conversion according to the distances from the original keywords, and assign ordinal ranks to the texts after conversion on the basis of the weighting.

According to this embodiment, effects described below are achieved.

The first effect is automatization of inspiration support. This can be achieved because a text of a different inspiration can be automatically produced by using a mining-result text from text database 201 as an already-existing inspiration and by converting keywords in the already-existing inspiration into different keywords.

The second effect is an improvement in efficiency of inspiration support. This can be achieved because mining results characterizing text database 201 are used as keywords to be converted, and because collation section 205 collates keyword conversion results with text database 201 and ranks the conversion results on the basis of the collation results to enable presentation of a thing, which can easily lead to a new inspiration, with priority.

### Exemplary Embodiment

The next embodiment will be described by using a specific exemplary embodiment.

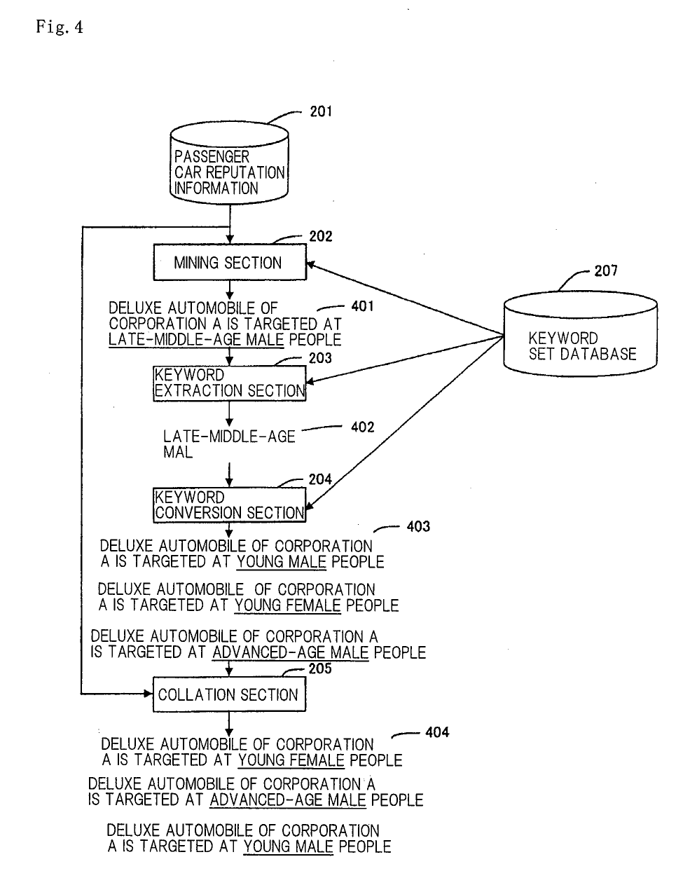

FIG. 4 is a block diagram showing an exemplary embodiment of the present invention. In FIG. 4, the components identical to those shown in FIG. 2 are indicated by the same reference numerals.

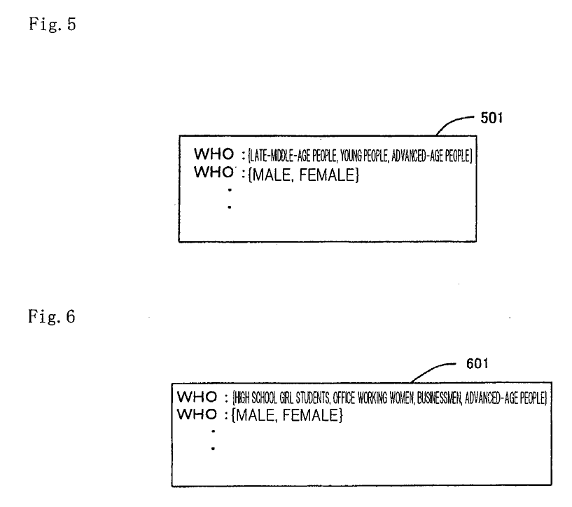

FIG. 5 is an explanatory diagram showing an example of conversion keywords stored in keyword set database 207.

Referring to FIG. 5, “young people”, “late-middle-age people” and “advanced-age people”, which are conversion keywords, are associated with “who”, and “male” and “female”, which are conversion keywords, are associated with “who”.

In the following, the group “young people”, “late-middle-age people” and “advanced-age people” associated with “who” and the group “male” and “female” associated with “who” are each referred to as a conversion keyword set.

Information on passenger car reputations is assumed to be used.

In text database 201, information on reputations of a plurality of passenger cars is stored as texts. In this case, a domain for each text stored in text database 201 is “passenger car reputation information”.

It is assumed that mining section 202 performs mining on the information about the reputations of a plurality of passenger cars stored in text database 201 to obtain result 401, “The deluxe automobile of Corporation A is targeted at late-middle-age male people”. This result 401 is a sentence on which 4W1H conversion is performed.

Keyword extraction section 203 extracts as keywords “late-middle-age” and “male” 402 corresponding to “who” from mining result 401. For example, keyword extraction section 203 extracts, from mining result 401, as keywords corresponding to “who”, the keywords that coincide with the keywords (“late-middle-age”, “young” or “advanced age”, “male” or “female”) associated with “who” in keyword set database 207.

Keyword conversion section 204 converts the keywords in mining result 401 extracted by keyword extraction section 203 into conversion keywords by referring to keyword set database 207, thereby producing a plurality of conversion results 403.

More specifically, keyword conversion section 204 converts “late-middle-age” in mining result 401 into “young” and “advanced-age” related to “late-middle-age” by referring to keyword set database 207 to produce texts after conversion (conversion results 403): “The deluxe automobile of Corporation A is targeted at young male people” and “The deluxe automobile of Corporation A is targeted at advanced-age male people”.

Also, keyword conversion section 204 converts “male” in mining result 401 into “female” that is related to “male” by referring to keyword set database 207 to produce the text after conversion: “The deluxe automobile of Corporation A is targeted at late-middle-age female people”.

Also, keyword conversion section 204 converts “late-middle-age” in mining result 401 into “young” that is related to “late-middle-age” by referring to keyword set database 207 and also converts “male” in mining result 401 into “female” that is related to “male”, thereby producing the text after conversion: “The deluxe automobile of Corporation A is targeted at young female people”.

Also, keyword conversion section 204 converts “late-middle-age” in mining result 401 into “advanced-age” that is related to “late-middle-age” by referring to keyword set database 207 and also converts “male” in mining result 401 into “female” that is related to “male”, thereby producing the text after conversion: “The deluxe automobile of Corporation A is targeted at advanced-age female people”.

Conversion results 403 are produced in correspondence with the number of combinations of the keywords.

Then collation section 205 collates conversion results 403 with the texts in text database 201 and assigns, for example, ordinal ranks in ascending order respectively to conversion results 403 in ascending order of the frequency in which the corresponding texts have appeared in text database 201, thereby rearranging conversion results 403. As a result, collation result 404, “The deluxe automobile of Corporation A is targeted at young female people”, for example is obtained with high priority.

Collation result 404 that does not exist in text database 201 is presented preferentially. Therefore, such a collation result is probable to become a new inspiration (a latent need).

As conversion keyword sets stored in keyword set database 207, sets of keywords such as synonyms and antonyms used in mining section 202, for example, may be used. In such a case, synonyms and antonyms used in mining can also be used as conversion keywords.

Also, conversion keyword sets can be dynamically changed according to domains that are objects for mining.

For example, it is assumed that keywords such as “male”, “female”, “young” and “advanced-age” (conversion keyword candidates) exist originally in keyword set database 207 and are associated with domains in advance. One keyword may be associated with a plurality of domains. In such a case, when a domain is determined, keywords associated with the domain are determined. This correspondence relationship is registered in advance in keyword conversion section 204.

If a set, which is formed of keywords associated with each domain, is used as a set of conversion keyword candidates for the domain, the conversion keyword set that is most suitable for each domain can be dynamically changed.

For example, keyword conversion section 204 accepts a domain in text database 201 and uses, as conversion keywords, keywords associated with the domain in advance.

In this case, conversion keywords are changed in correspondence with texts stored in text database 201. Thus, conversion of a text stored in text database 201 can be made by using the conversions keywords that are most suitable for the text.

The keyword sets shown in FIG. 5 correspond to “passenger car reputation information” (domain), and the keyword sets shown in FIG. 6 correspond to “portable telephone reputation information” (domain). As can be understood from a comparison therebetween, the keyword “advanced-age” belongs to the different sets.

Accordingly, while the keyword “advanced-age” is converted into “late-middle-age” and “young” in the case of managing “passenger car reputation information”, the same keyword “advanced-age” is converted into “high school girl students”, “office working women” and “businessmen” in the case of managing “portable telephone reputation information”. Thus, more efficient inspiration support can be achieved.

While the present exemplary embodiment has been described with respect to only “who” in the 4W1H conversion object keywords, the same conversion can be made with respect to other different keywords (why, where, when, how). Conversion object keywords are not limited to 4W1H. For example, 5W1H prepared by adding “what” may be used. The same processing as that described above can also be performed in the case where conversion object keywords are 5W1H.

According to the present exemplary embodiment, a mining result characterizing text database 101 is used as a text in which keywords are to be converted, and a text that has a meaning different from that of the mining result is automatically produced by keyword conversion performed in keyword extraction section 203 and keyword conversion section 204. Inspiration of a new idea is supported by means of the text that has been produced.

Thus, automatization of inspiration support is enabled to make it possible to perform inspiration support with efficiency. Also, use of text mining for inspiration support is made possible.

In the present exemplary embodiment, collation section 205 collates a text converted by keyword conversion section 204 with texts in text database 201, and ranks the text on the basis of the result of collation.

In this case, an ordinal rank can be assigned to the text in which keywords have been converted (text after conversion) on the basis of differences between the contents of the text after conversion and the contents of the texts in text database 201. Therefore, for example, a text, which is different in meaning from the texts in text database 201 and which is likely to enable support of a new idea, can be assigned a higher ordinal rank.

If texts in which keywords have been converted (texts after conversion) are rearranged according to their ordinal ranks, a user can easily find the text likely to enable support of a new idea.

In the present exemplary embodiment, collation section 205 assign a higher ordinal rank to a text converted by keyword conversion section 204 if the frequency with which the text has appeared in text database 201 is lower.

In this case, a text which is different in meaning from the texts in text database 201 and which is likely to enable support of a new idea can be assigned a higher ordinal rank.

In the above-described exemplary embodiment, the illustrated configuration is only an example, and the present invention is not limited to the illustrated configuration.

### INDUSTRIAL APPLICABILITY

The present invention can be applied to use, for example, for inspiration support and discovery of latent needs at the time of product planning or devising a strategy.

1. An inspiration support apparatus comprising:
a text database that stores a plurality of texts;
a text mining section that analyzes the plurality of texts stored in the text database by text mining, and outputs a text that is a result of the mining;
a keyword set database that stores a keyword set that contains conversion keywords corresponding to words that express 4W1H that is made up of who, why, where, when and how;
a keyword extraction section that extracts the keywords corresponding to the words that express 4W1H from the text that is the result of the mining by referring to the keyword set database;
a keyword conversion section that converts, with respect to the text that is the result of the mining, the keywords extracted by the keyword extraction section in the text into one of the conversion keywords contained in the keyword set including the keywords; and
a result output section that outputs the text converted by the keyword conversion section.

2. The inspiration support apparatus according to claim 1, further comprising a collation section that collates the text converted by the keyword conversion section with the texts in the text database and assigns an ordinal rank to the converted text on the basis of a result of collation, wherein the result output section outputs the converted text having the ordinal rank assigned by the collation section.

3. The inspiration support apparatus according to claim 1, wherein the keyword set database stores as the conversion keywords synonyms or antonyms to be used in the text mining section.

4. The inspiration support apparatus according to claim 1, wherein the keyword set database stores a plurality of conversion keyword candidates, and the keyword conversion section uses as the conversion keyword one of the conversion keyword candidates associated in advance with the texts stored in the text database.

5. The inspiration support apparatus according to claim 2, wherein the collation section assigns a higher ordinal rank to the text converted by the keyword conversion section if frequency with which the text has appeared in the text database is lower.

6. An inspiration support method carried out by an inspiration support apparatus including a text database that stores a plurality of texts and a keyword set database that stores a keyword set that contains conversion keywords corresponding to words that express 4W1H that is made up of who, why, where, when and how, the method comprising:
analyzing the plurality of text database by text mining to output a text that is a result of the mining;
extracting the keywords corresponding to the words that express 4W1H from the text that is the result of the mining by referring to the keyword set database;
converting, with respect to the text that is the result of the mining, the extracted keywords in the text into one of the conversion keywords contained in the keyword set including the keywords; and
outputting the converted text.

7. The inspiration support method according to claim 6, further comprising collating the converted text with the texts in the text database and assigning an ordinal rank to the converted text on the basis of a result of collation, wherein, the outputting comprises outputting the converted text assigned the ordinal rank.

8. The inspiration support method according to claim 6, wherein the keyword set database stores as the conversion keywords synonyms or antonyms to be used in the text mining.

9. The inspiration support method according to claim 6, wherein the keyword set database stores a plurality of conversion keyword candidates, and the converting includes using as the conversion keyword one of the conversion keyword candidates associated in advance with the texts stored in the text database.

10. The inspiration support method according to claim 7, wherein, the collating comprises assigning a higher ordinal rank to the converted text if frequency with which the text has appeared in the text database is lower.

11. An inspiration support program causing a computer, which is connected to a text database that stores a plurality of texts and a keyword set database that stores a keyword set that contains conversion keywords corresponding to words that express 4W1H that is made up of who, why, where, when and how, to execute inspiration support processing including:
text mining processing for analyzing the plurality of texts stored in the text database by text mining to output a text that is a result of the mining;
keyword extraction processing for extracting the keywords corresponding to the words that express 4W1H from the text that is the result of the mining by referring to the keyword set database;
keyword conversion processing for converting, with respect to the text that is the result of mining, the extracted keywords in the text into one of the conversion keywords contained in the keyword set including the keywords; and
result output processing for outputting the converted text.

12. The inspiration support program according to claim 11, wherein the inspiration support processing further includes collation processing for collating the converted text with the texts in the text database and assigning an ordinal rank to the converted text on the basis of a result of collation, wherein, in the result output processing, the converted text assigned the ordinal rank is output.

13. The inspiration support program according to claim 11, wherein the keyword set database stores as the conversion keywords synonyms or antonyms to be used in the text mining processing.

14. The inspiration support program according to claim 11, wherein the keyword set database stores a plurality of conversion keyword candidates, and the keyword conversion processing includes using as the conversion keyword one of the conversion keyword candidates associated in advance with the texts stored in the text database.

15. The inspiration support program according to claim 12, wherein, in the collation processing, a higher ordinal rank is assigned to the converted text if frequency with which the text has appeared in the text database is lower.

16-18. (canceled)

19. A computer readable recording medium on which a program is embedded, the program causing a computer, which is connected to a text database that stores a plurality of texts and a keyword set database that stores a keyword set that contains conversion keywords corresponding to words that express 4W1H that is made up of who, why, where, when and how, to execute inspiration support processing including:
text mining processing for analyzing the plurality of texts stored in the text database by text mining to output a text that is a result of the mining;
keyword extraction processing for extracting the keywords corresponding to the words that express 4W1H from the text that is the result of the mining by referring to the keyword set database;
keyword conversion processing for converting, with respect to the text that is the result of mining, the extracted keywords in the text into one of the conversion keywords contained in the keyword set including the keywords; and
result output processing for outputting the converted text.

20. The inspiration support apparatus according to claim 1, wherein the keyword set contains the conversion keywords corresponding to words that express 5W1H that is further made up of what, and the keyword extraction section extracts the keywords corresponding to the words that express 5W1H from the text that is the result of the mining.

21. An inspiration support apparatus comprising:
text database means for storing a plurality of texts;
text mining means for analyzing the plurality of texts stored in the text database means by text mining, and for outputting a text that is a result of the mining;
keyword set database means for storing a keyword set that contains conversion keywords corresponding to words that express 4W1H that is made up of who, why, where, when and how;
keyword extraction means for extracting the keywords corresponding to the words that express 4W1H from the text that is the result of the mining by referring to the keyword set database means;
keyword conversion means for converting, with respect to the text that is the result of the mining, the keywords extracted by the keyword extraction means in the text into one of the conversion keywords contained in the keyword set including the keywords; and
result output means for outputting the text converted by the keyword conversion means.

22. The inspiration support method according to claim 6, wherein the keyword set contains the conversion keywords corresponding to words that express 5W1H that is further made up of what, and the extracting comprises extracting the keywords corresponding to the words that express 5W1H from the text that is the result of the mining.

23. The inspiration support program according to claim 11, wherein the keyword set contains the conversion keywords corresponding to words that express 5W1H that is further made up of what, and the keyword extraction processing comprises extracting the keywords corresponding to the words that express 5W1H from the text that is the result of the mining.
